(19) United States
(12) Patent Application Publication
(10) Pub. No.: US 2025/0005427 A1
(43) Pub. Date: Jan. 2, 2025

(54) DIALOGUE STATE TRACKING WITH IN-CONTEXT TUNING

(71) Applicant: International Business Machines Corporation, Armonk, NY (US)

(72) Inventors: Praveen Venkateswaran, Cambridge, MA (US); Evelyn Duesterwald, Yorktown Heights, NY (US); Vatche Isahagian, Cambridge, MA (US)

(21) Appl. No.: 18/215,312

(22) Filed: Jun. 28, 2023

(51) Int. Cl. G06N 20/00; G06F 40/35; G06F 40/40

(52) U.S. Cl. CPC G06N 20/00; G06F 40/35; G06F 40/40

(57) ABSTRACT

Methods, systems, and computer program products for dialogue state tracking with in-context tuning are provided herein. A computer-implemented method includes obtaining input dialogue data; identifying, from at least one historical dialogue dataset, one or more historical dialogue examples having at least a given semantic similarity to at least a portion of the input dialogue data; generating, based on the one or more historical dialogue examples, one or more prompts related to at least a portion of the input dialogue data; generating tuning data, associated with at least one dialogue state tracking task related to the input dialogue data, for one or more artificial intelligence techniques by augmenting at least a portion of the prompt(s) in connection with at least one given dialogue state value derived from at least a portion of the historical dialogue dataset(s); and performing one or more automated actions based on the generated tuning data.

### STATEMENT REGARDING PRIOR DISCLOSURES BY THE INVENTOR OR A JOINT INVENTOR

The following disclosure(s) are submitted under 35 U.S.C. 102 (b) (1) (A): DISCLOSURE(S): Venkateswaran et al., DISTRICT: Dialogue State Tracking with Retriever Driven In-Context Tuning, arXiv: 2212.02851v1, Dec. 6, 2022.

### BACKGROUND

The present application generally relates to information technology and, more particularly, to language processing. More specifically, task-oriented conversation systems are implemented in many contexts. However, conventional automated conversation approaches commonly rely on resource-intensive design techniques, which can be error-prone and limiting with respect to applicability to new and/or additional domains.

### SUMMARY

In at least one embodiment, techniques for dialogue state tracking with in-context tuning are provided.

An example computer-implemented method includes obtaining input dialogue data, and identifying, from at least one historical dialogue dataset, one or more historical dialogue examples having at least a given semantic similarity to at least a portion of the input dialogue data. The method also includes generating, based at least in part on the one or more historical dialogue examples, one or more prompts related to at least a portion of the input dialogue data. Further, the method includes generating tuning data, associated with at least one dialogue state tracking task related to the input dialogue data, for one or more artificial intelligence techniques by augmenting at least a portion of the one or more prompts in connection with at least one given dialogue state value derived from at least a portion of the at least one historical dialogue dataset. Additionally, the method includes performing one or more automated actions based at least in part on the generated tuning data.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture for dialogue state tracking with retriever-driven in-context model tuning, according to an example embodiment of the invention;

FIG. 2 is a diagram illustrating system architecture related to an in-context retriever, according to an example embodiment of the invention;

FIG. 3 is a diagram illustrating a table of example slot value determinations, according to an example embodiment of the invention;

FIG. 4A is a diagram illustrating an example in-context model tuning workflow for dialogue state tracking, according to an example embodiment of the invention;

FIG. 4B is a diagram illustrating an example in-context learning-based prediction workflow for dialogue state tracking, according to an example embodiment of the invention;

FIG. 5 is a flow diagram illustrating techniques according to an example embodiment of the invention; and

FIG. 6 is a diagram illustrating a computing environment in which at least one embodiment of the invention can be implemented.

### DETAILED DESCRIPTION

As described herein, at least one embodiment includes dialogue state tracking techniques using retriever-driven in-context tuning. By way merely of example, a typical process might include initially training a large language model (LLM) on vast amounts of text data (e.g., text available on the internet), a step also referred to a “pre-training,” which provides general purpose knowledge for the LLM. After such pre-training, one or more embodiments, as further detailed herein, can include tuning (also referred to herein as fine-tuning) such an LLM for at least one specific task (such as, e.g., a dialogue state tracking task), wherein such tuning enhances the performance of the LLM for that at least one specific task. Similar to pre-training, tuning includes a training phase wherein one or more weights of the LLM are updated. After tuning a LLM for a dialogue state tracking task, the tuned LLM can be used to predict dialogue states from a given input and/or current dialogue context. Additionally or alternatively, dialogue state tracking tuning data can include historical dialogue snippets and the corresponding dialogue states as the label. Further, at least one embodiment can include using in-context learning techniques (e.g., inclusion of similar examples) that are typically only used during prediction time to craft enhanced prompts which can achieve and/or facilitate an improved fine-tuned LLM.

Dialogue state tracking, as used herein, refers to a component of task-oriented conversation systems which represents user intentions by determining values of predefined slots in an ongoing dialogue. Accordingly, and as further detailed herein, one or more embodiments include generating and/or implementing a generalizable in-context tuning approach for dialogue state tracking that retrieves relevant training examples for a given dialogue to fine-tune the corresponding model(s) without the need and/or use of manually crafted templates. Such an embodiment includes implementing an in-context learning approach for creating one or more prompts, which are then used to create new and/or enhanced tuning data to fine-tune a pre-trained language model such that the model achieves improved performance for at least one corresponding language processing task (e.g., a dialogue state tracking task).

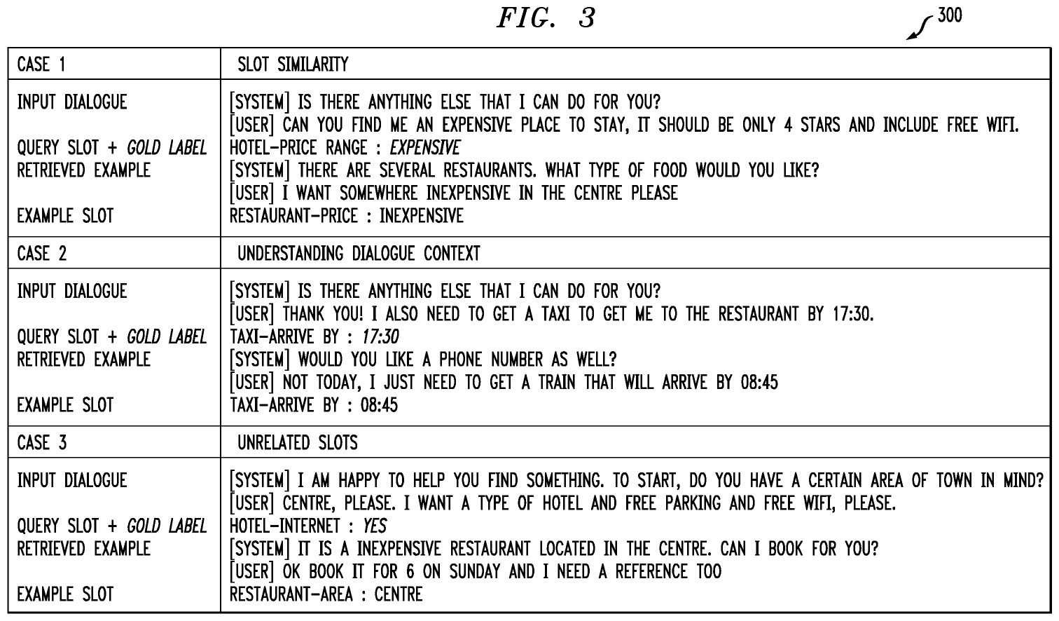

More specifically, at least one embodiment includes providing dialogue state tracking of one or more user objectives in multi-domain conversational systems with retriever-driven in-context tuning which combines model fine-tuning with one or more in-context examples. For example, such an embodiment can include obtaining and/or receiving at least one dialogue input example and at least one set of slots comprising a given dialogue state. In one or more embodiments, the dialogue state represents the ground truth and includes a number of slots, wherein a slot refers to a dialogue state variable (such as, for example, “hotel-price range” in Case 1 in FIG. 3). The dialogue state can include the current value of that variable at a specific point in the dialogue (in the FIG. 3 example, the state for “hotel-price range” is “expensive” at the end of the input dialogue of Case 1). Accordingly, the state of a dialogue is a collection of <slot, value> pairs that are present until that turn of the dialogue. For example, if a dialogue includes a user providing information about their hotel requirements and price range, all of those <slot, value> pairs would comprise the entirety of the dialogue state.

Further, such an embodiment includes retrieving semantically similar dialogue examples from available training data, and generating at least one prompt based at least in part on the input and the retrieved examples. Additionally, such an embodiment includes predicting, based at least in part on the at least one generated prompt, a set of one or more dialogue states using at least one artificial intelligence model (e.g., at least one trained or fine-tuned language model such as a transformer model, a FLAN-T5 model, a GPT2 model, etc.).

As such, one or more embodiments include tuning, in a dialogue state tracking context, one or more artificial intelligence techniques (e.g., one or more LLMs) using one or more in-context examples. Such an embodiment includes leveraging relevant existing dialogue and slot examples to improve generalizability and reduce manual overhead. As used herein, a slot refers to a parameter or variable to be tracked (e.g., tracked by an automated conversation system) based at least in part on the user's input. For instance, hotel-price-range, flight-destination, etc. are examples of slots that a travel-based system might track. In one or more embodiments, a set of slots can be predefined in an ontology and provided to a model a priori for dialogue state tracking. Also, each such slot defined can have a corresponding value in a dialogue depending on whether or not the user provided information related thereto, and the set of <slot, value> pairs across a dialogue corresponds to the dialogue's state.

More specifically, at least one embodiment can include leveraging semantic similarity between dialogue embeddings to identify dialogue examples similar to an input dialogue. Such examples can then be used at least in part to generate at least one prompt which enables a corresponding artificial intelligence model (e.g., at least one language model, at least one encoder-decoder model, at least one decoder-only model, etc.) to learn from the examples for effective dialogue state tracking performance. Additionally, the use of semantic similarity to construct prompts enables one or more embodiments to generalize to one or more new and/or additional domains without requiring example dialogues from such domains.

Accordingly, at least one embodiment includes generating one or more prompts for one or more artificial intelligence techniques (e.g., at least one language model) by identifying and processing one or more example dialogues that are semantically similar to at least a portion of a given input dialogue. In such an embodiment, determining semantic similarity can include using one or more text and/or sentence similarly metrics. In one or more embodiments, instead of using a threshold, such an embodiment can include limiting the number of examples to include in a prompt (e.g., three examples) and determining the k most similar examples according to the chosen text and/or sentence similarity metric. Such one or more prompts can then be used to train and/or tune the one or more artificial intelligence techniques.

Additionally, the one or more generated prompts can be encoded by the one or more artificial intelligence techniques and used to predict one or more slot values in connection with the given input dialogue. Further, such an embodiment includes precluding a requirement that candidate values be defined for one or more slots, which can result in a scalable approach that can be generalized and/or applicable to one or more new and/or additional domains (e.g., domains other than one or more domains associated with the given input dialogue).

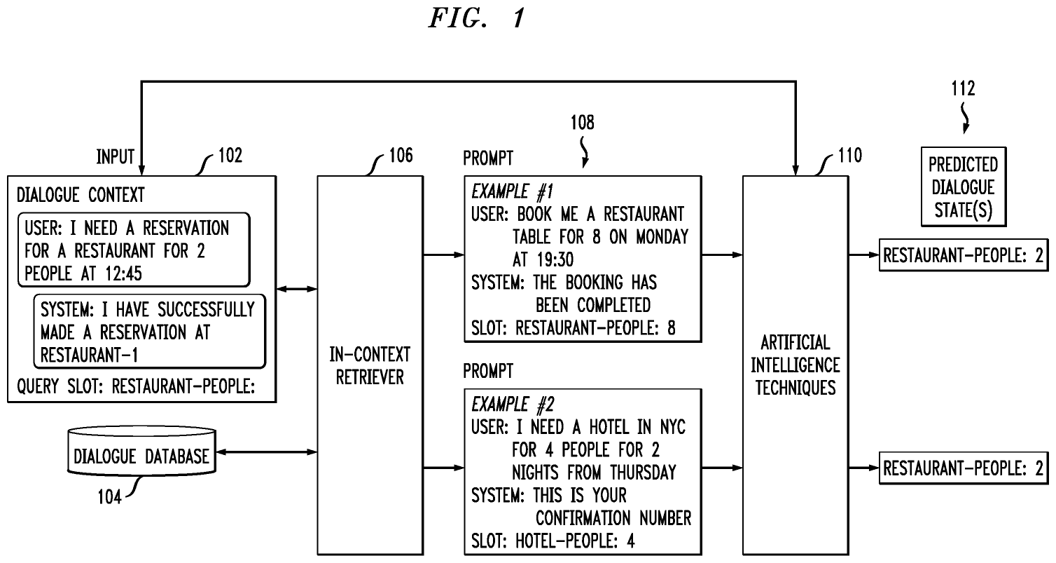

FIG. 1 is a diagram illustrating system architecture for dialogue state tracking with retriever-driven in-context model tuning, according to an example embodiment of the invention. By way of illustration, FIG. 1 depicts input 102, which includes dialogue content and query slot information, and a dialogue database 104 which contains in-context examples. In the example depicted in FIG. 1, the dialogue content can include a user stating a need for a reservation at a restaurant for two people at 12:45, and an automated conversation system responding that a reservation has successfully been made at a restaurant. Also, in the example input 102, the query slot information includes restaurant-people. As noted herein, in one or more embodiments, the set of all possible slots for the dialogue and/or system can be predefined in an ontology. In such an embodiment, the query slot can be identified by querying the model for the value of one slot at a time from the ontology.

FIG. 1 also depicts in-context retriever 106, which processes at least a portion of the input 102 and at least a portion of the in-context examples from dialogue database 104. More specifically, given input dialogue content and query slot information to be tracked, one or more relevant examples of dialogue data can be identified from dialogue database 104 by the in-context retriever 106 and used to create one or more prompts. Also, in one or more embodiments, and as also illustrated in FIG. 1, in-context retriever 106 can process such data with respect to a zero-shot context as well as a few-shot context. In connection with a zero-shot context, in-context retriever 106 searches for semantically similar dialogues and slots from other domains from that of the input 102, while in connection with a few-shot context, in-context retriever 106 has access to example dialogues (as well as query slot information, in some instances) from the same domain as the input 102.

In one or more embodiments, the in-context retriever 106 selects one or more historical dialogues that are available in at least one training set. The selection can be based at least in part on one or more of random selection, fixed selection of the same examples, most semantically similar examples, etc.

As noted above, in-context retriever 106 processes input 102 and example dialogue data from dialogue database 104 to generate one or more prompts 108. Referring to the above-noted example dialogue content pertaining to a restaurant reservation, in a zero-shot context, such a prompt 108 can include, for instance, a user stating a need for a hotel in NYC for four people for two nights beginning Thursday, and an automated conversation system responding with a confirmation number. Also, in such an example, the slot information can include hotel-people: 4. In a few-shot context, such a prompt 108 can include, for instance, a user stating a need for the booking of a restaurant table for eight people on Monday at 19:30, and an automated conversation system responding that a booking has been completed. Also, in such an example, the slot information can include restaurant-people: 8.

As also depicted in FIG. 1, the one or more prompts 108 can then be provided to and/or used to train or tune one or more artificial intelligence techniques 110 (e.g., at least one language model). The trained/tuned artificial intelligence techniques 110 can then process at least a portion of input 102 and generate one or more predicted dialogue states 112. In the example depicted in FIG. 1, artificial intelligence techniques 110 predicts, in both a zero-shot context and a few-shot context, a dialogue state of restaurant-people: 2.

As detailed herein, a task-oriented dialogue typically includes a multi-turn conversation between a user U and an automated conversation system A. Given a dialogue context Cₜ as the sequence of utterances in the dialogue until turn t, (i.e.) Cₜ=[A₁, U₁, . . . , Aₜ, Uₜ], a goal of dialogue state tracking includes predicting the dialogue state yₜ, defined as a set of (slot, value) pairs:

$${y}_{t} = \{ ( {s}_{t}^{i} , {v}_{t}^{i} ) \vert {C}_{t} , {∀}_{s} i ∈ S \}$$

wherein s denotes the set of possible slots predefined in an ontology or schema. In a multi-domain setting, the ontology or schema can include different domains and/or topics, each corresponding, for example, to a service such as restaurant booking, banking, etc. The slots associated with each domain can be categorical with a set of candidate values (e.g., restaurant-open=‘True’/‘False’) and/or non-categorical, wherein the value is a span in the dialogue context (e.g., hotelname=‘Hotel CompanyX’).

Referring again to FIG. 1, in-context retriever 106 identifies semantically relevant in-context examples from the available training set of dialogues (e.g., stored in dialogue database 104). In one or more embodiments, historical labeled dialogues can be stored (e.g., in dialogue database 104) containing information about slots and corresponding values under different conversation contexts. Accordingly, for an input dialogue (e.g., input 102) and at least one given query slot, at least one embodiment includes conditioning one or more artificial intelligence techniques 110 (e.g., a language model) during training or tuning using example dialogues that are semantically similar and additionally contain the same or similar slots to the input dialogue. Such an embodiment includes enabling and/or facilitating the one or more artificial intelligence techniques to better learn one or more associations between slots, slot values, and context information.

As shown in the FIG. 1 example, in-context retriever 106 performs semantic matching of the input dialogue and slot information using, for example, single-turn training set conversations as examples (e.g., one pair of user-system utterances) from dialogue database 104. In such an example embodiment, constraining the in-context examples to single-turn conversations reduces the prompt size, enables the addition and/or inclusion of more examples, and limits and/or removes irrelevant dialogue context.

One or more embodiments can include defining a dataset D={(eⱼ, sⱼⁱ, vⱼⁱ)} including single-turn dialogue examples eⱼ, containing an observed slot sⱼⁱ and its corresponding value vⱼⁱ. For a given input dialogue context Cₜ and query slot s^{q}, such an embodiment includes retrieving the k most relevant examples εₖ∈D based on the similarity between their text embeddings:

$${ε}_{k} = {max}_{k} \{ sim ( {C}_{t}^{emb} , {D}^{emb} ) \}$$

Accordingly, in at least one embodiment, an in-context retriever is implemented to identify relevant examples similar to input dialogue data. Based at least in part on the semantic similarity of dialogues and slots thereof, such an embodiment includes enabling artificial intelligence techniques (e.g., one or more language models), via training and/or tuning, to learn from similar examples to understand potential slot values to input dialogues.

As detailed herein, one or more embodiments can be implemented in zero-shot settings, which can include a lack of access to example dialogues from the same domain as an input dialogue. In such an embodiment, an in-context retriever identifies semantically similar dialogues and slots thereof from one or more other domains. By way merely of example and illustration, consider a test input dialogue from the restaurant domain and a query slot of restaurant-people. In such an example, the in-context retriever identifies the k most relevant single-turn in-context examples derived from the corresponding training set.

In a zero-shot setting, dialogue and slot examples from the restaurant domain would not be available. Accordingly, the in-context retriever can identify semantically similar examples from one or more other domains. For instance, it can be determined that conversations about hotel reservations have similar contexts to conversations about restaurant reservations, and the slot hotel-people is semantically similar to the input query slot. The example(s) retrieved and/or identified by the in-context retriever can thus be used to train and/or tune one or more artificial intelligence techniques (e.g., at least one learning model) to look for the number of people mentioned in the dialogue.

As also detailed herein, one or more embodiments can be implemented in few-shot settings, which can include access to a given and/or limited amount of example dialogues from the same domain as an input dialogue (e.g., possibly containing the same slot as an input query slot). In such an embodiment, an in-context retriever identifies semantically similar dialogues and slots thereof from the same domains.

Accordingly, in few-shot settings, the set of available examples would include other dialogues from the same domain, which can also contain the query slot. Hence, the most similar examples retrieved by an in-context retriever would demonstrate the values of the query slot when used in a similar dialogue context (e.g., a similar restaurant reservation context such as, for example, a query slot of restaurant-people: 8). One or more embodiments include requiring no changes for different settings, and enabling extension to include additional information such as, for example, slot descriptions, to further enhance semantic similarity-based retrieval(s).

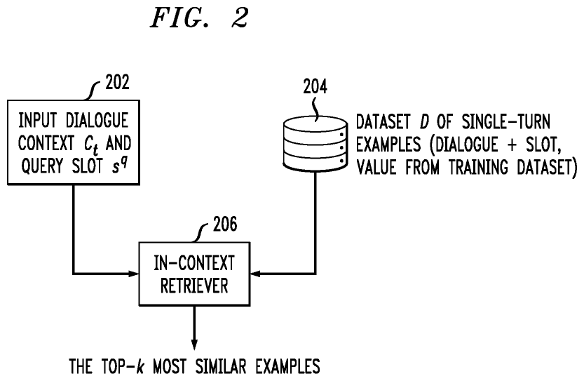

FIG. 2 is a diagram illustrating system architecture related to an in-context retriever, according to an example embodiment of the invention. By way of illustration, FIG. 2 depicts input 202 which includes dialogue context Cₜ and query slot s^{q}. Also, FIG. 2 depicts database 204 which includes dataset D of single-turn examples (i.e., dialogue and (slot, value) pairs from training data). At least a portion of data from input 202 and database 204 is processed by in-context retriever 206 to identify the top-k most semantically similar examples, determined by comparing the similarity of embeddings therein.

By way of further illustration and example, to generate input to be used to train one or more artificial intelligence techniques (e.g., at least one language model), at least one embodiment includes annotating prefixes to each of k in-context examples Σₖ, dialogue context Cₜ, and query slot s^{q} to enable the one or more artificial intelligence techniques to distinguish between such data types and/or categories, and concatenate such data types and/or categories into a single input sequence. In one or more embodiments, the concatenation is performed by appending different information, one after another, separated by a token that the model (e.g., an LLM) recognizes. The separation allows the model to know that the information needs to be considered as distinct from each other.

Such an embodiment can then include training and/or tuning at least a portion of the one or more artificial intelligence techniques such as, e.g., an encoder-decoder-based language model, where the input sequence is passed to the encoder, and the decoder generates the corresponding value for the query slot. In such an example embodiment, the encoder-decoder-based language model in-context tuning objective L can be to minimize the negative log-likelihood loss in accordance with the following equation:

$$L ( θ ) = - {\sum }_{i = 0}^{n} log p ( {v}_{i} \vert {ε}_{k} ⊕ {C}_{t} ⊕ {s}^{q} )$$

wherein n is the total number of slots in the ontology and @ denotes concatenation.

FIG. 3 is a diagram illustrating a table 300 of example slot value determinations, according to an example embodiment of the invention. By way of illustration, in Case 1, a conventional dialogue state tracking training example can include (input dialogue+query slot), and the label for this example would be what is shown in italic as the gold label. Using an in-context tuning approach such as detailed in connection with one or more embodiments, the conventional dialogue state tracking training example is augmented to also include one or more retrieved examples with a corresponding example slot. As such, the augmented in-context tuning example includes (input dialogue+query slot+one or more retrieved examples with their example slots), and the label continues to be what is shown in italics as the gold label.

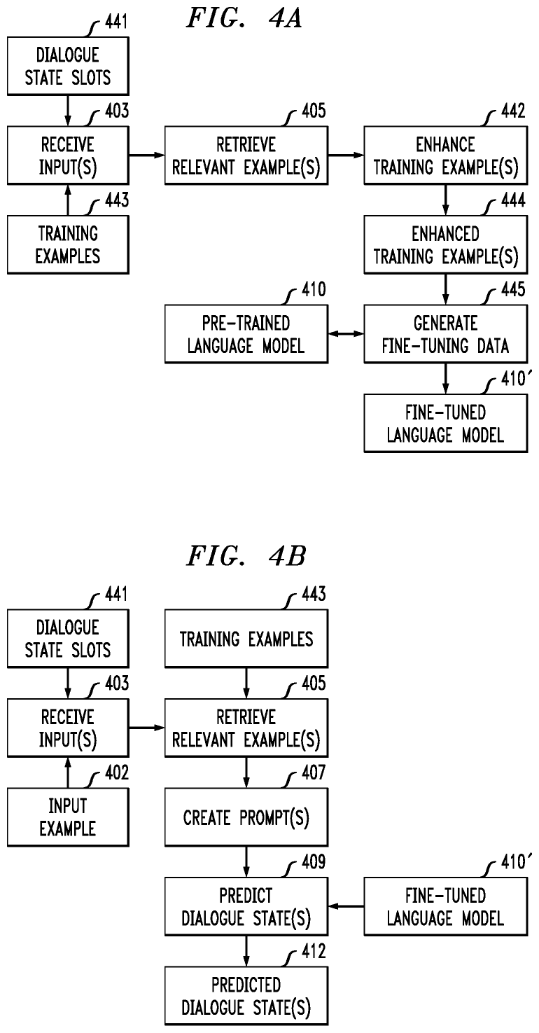

FIG. 4A is a diagram illustrating an example in-context model tuning workflow for dialogue state tracking, according to an example embodiment of the invention. By way of illustration, FIG. 4A depicts an in-context fine-tuning flow to produce a fine-tuned language model. Specifically, one or more inputs are received in step 403, wherein such input(s) can include dialogue state slots 441 and training examples 443. In one or more embodiments, each training example is of the form (input, output), wherein the input includes a dialogue snippet, and the output includes a set of dialogue states derivable from the dialogue snippet. Referring again to FIG. 4A, step 405 includes retrieving one or more relevant examples based at least in part on the one or more inputs received in step 403. In at least one embodiment, for each training example (from training examples 443), a set of other examples is retrieved from the pool of available training examples 443 that are most relevant based on at least one relevance metric.

Step 442 includes enhancing at least one training example (e.g., the relevant example(s) retrieved in step 405). For example, from an original training example E and the retrieved most relevant other examples, at least one embodiment includes creating an enhanced version of that training example in the form of (input, output), wherein the input includes one or more relevant examples for E followed by the original input of E, and the output includes the original output of E. The one or more enhanced training examples 444, generated via step 442, are then used in step 445 to generate fine-tuning data. The generated fine-tuning data are then used to train and/or fine-tune pre-trained language model 410, rendering and/or generating fine-tuned language model 410′.

FIG. 4B is a diagram illustrating an example in-context learning-based prediction workflow for dialogue state tracking, according to an example embodiment of the invention. By way of illustration, FIG. 4B depicts a prediction flow, using in-context learning in association with the techniques depicted in FIG. 4A, to predict one or more dialogue states for a new and/or previously unseen input example. Specifically, one or more inputs are received in step 403, wherein such input(s) can include dialogue state slots 441 and an input example 402, which includes a new and/or previously unseen input pulled from an ongoing dialogue.

Step 405 includes retrieving one or more relevant examples, based at least in part on the received input in step 403, from training examples 443. Step 407 includes creating one or more prompts based at least in part on the one or more retrieved examples in step 405. Further, at least a portion of the one or more prompts created in step 407 are used in connection with fine-tuned language model 410′ to predict one or more dialogue states in step 409 and output at least a portion of such predicted dialogue state(s) 412.

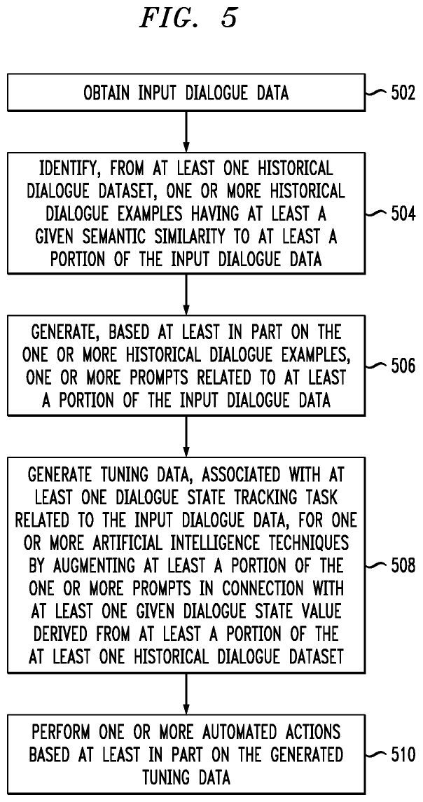

FIG. 5 is a flow diagram illustrating techniques according to an embodiment of the present invention. Step 502 includes obtaining input dialogue data. In at least one embodiment, obtaining input dialogue data includes obtaining dialogue content involving at least one user and at least one automated conversation system, and query slot information related to the dialogue content.

Step 504 includes identifying, from at least one historical dialogue dataset, one or more historical dialogue examples having at least a given semantic similarity to at least a portion of the input dialogue data. In one or more embodiments, identifying one or more historical dialogue examples includes comparing semantic similarity of one or more embeddings within the input dialogue data and one or more embeddings within the at least one historical dialogue dataset.

Step 506 includes generating, based at least in part on the one or more historical dialogue examples, one or more prompts related to at least a portion of the input dialogue data. In at least one embodiment, generating one or more prompts includes generating, based at least in part on the one or more historical dialogue examples, one or more prompts related to at least a portion of the input dialogue data in at least one of a zero-shot context and a few-shot context.

Step 508 includes generating tuning data, associated with at least one dialogue state tracking task related to the input dialogue data, for one or more artificial intelligence techniques by augmenting at least a portion of the one or more prompts in connection with at least one given dialogue state value derived from at least a portion of the at least one historical dialogue dataset. In at least one embodiment, the at least one given dialogue state value represents the ground truth dialogue state, which includes a collection of one or more variables (also referred to herein as slots) and one or more values for those one or more variables.

Step 510 includes performing one or more automated actions based at least in part on the generated tuning data. In one or more embodiments, performing one or more automated actions includes automatically tuning the one or more artificial intelligence techniques using at least a portion of the generated tuning data. In such an embodiment, performing one or more automated actions can include predicting at least one dialogue state related to the input dialogue data by processing, using the one or more tuned artificial intelligence techniques, at least a portion of the input dialogue data. In one or more embodiments, predicting at least one dialogue related to the input dialogue data using the one or more tuned artificial intelligence techniques includes processing at least a portion of the input dialogue data in conjunction with at least a portion of the one or more prompts using at least one language model. In such an embodiment, the at least one language model includes one or more of at least one encoder-decoder model and at least one decoder-only model.

In at least one embodiment, performing one or more automated actions comprises automatically generating at least one response, based at least in part on the at least one predicted dialogue state, in connection with an automated conversation system involved in the input dialogue data. Additionally or alternatively, performing one or more automated actions can include automatically training at least a portion of the one or more tuned artificial intelligence techniques using feedback related to the at least one predicted dialogue state. Further, in one or more embodiments, performing one or more automated actions includes automatically training at least one multi-domain automated conversation system using the at least one predicted dialogue state.

Also, the techniques depicted in FIG. 5 can include training at least a portion of the one or more artificial intelligence techniques using at least a portion of the one or more prompts. In such an embodiment, training at least a portion of the one or more artificial intelligence techniques using at least a portion of the one or more prompts can include encoding the at least a portion of the one or more prompts and using, via the one or more artificial intelligence techniques, the encoded prompts to predict one or more slot values in connection with the input dialogue data.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented predictions. For example, one or more of the models described herein may be trained to generate predictions based at least in part on semantically similar dialogue data and/or examples, and such predictions can be used to initiate one or more automated actions (e.g., automatically generating at least one response in connection with an automated conversation system, automatically training one or more artificial intelligence techniques, etc.).

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as dialogue state tracking code 626. In addition to code 626, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and code 626, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

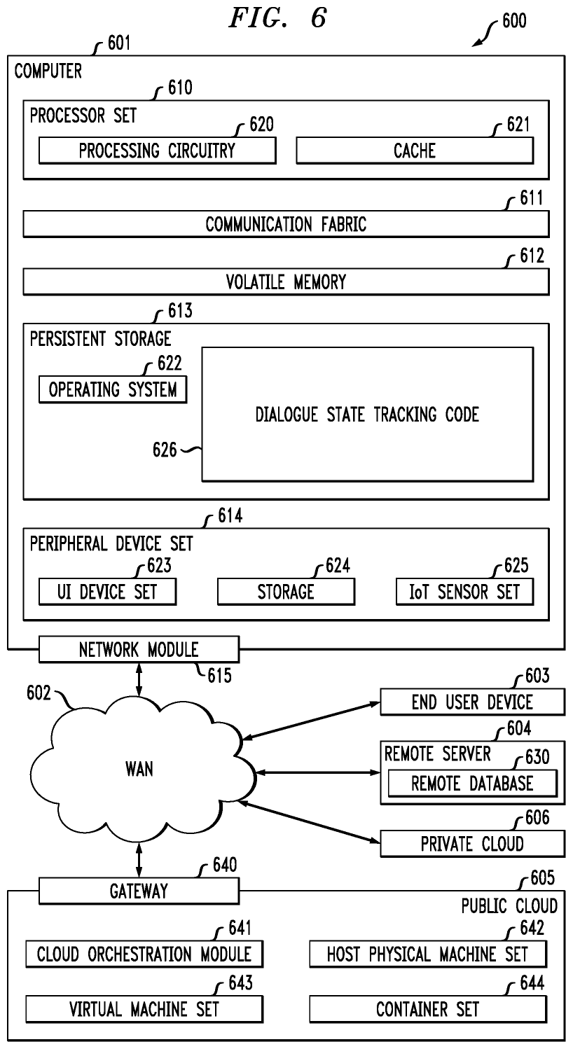

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in code 626 in persistent storage 613.

Communication fabric 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type RAM or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a ROM, but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in code 626 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

In computing environment 600, computer 601 is shown as being connected to the internet (see WAN 602). However, in many embodiments of the present invention computer 601 will be isolated from communicating over communications network and not connected to the internet, running as a standalone computer. In these embodiments, network module 615 of computer 601 may not be necessary or even desirable in order to ensure isolation and to prevent external communications coming into computer 601. The standalone computer embodiments are potentially advantageous, at least in some applications of the present invention, because they are typically more secure. In other embodiments, computer 601 is connected to a secure WAN or a secure LAN instead of WAN 602 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory configured to store program instructions; and
a processor operatively coupled to the memory to execute the program instructions to:
obtain input dialogue data;
identify, from at least one historical dialogue dataset, one or more historical dialogue examples having at least a given semantic similarity to at least a portion of the input dialogue data;
generate, based at least in part on the one or more historical dialogue examples, one or more prompts related to at least a portion of the input dialogue data;
generate tuning data, associated with at least one dialogue state tracking task related to the input dialogue data, for one or more artificial intelligence techniques by augmenting at least a portion of the one or more prompts in connection with at least one given dialogue state value derived from at least a portion of the at least one historical dialogue dataset; and
perform one or more automated actions based at least in part on the generated tuning data.

2. The system of claim 1, wherein performing one or more automated actions comprises automatically tuning the one or more artificial intelligence techniques using at least a portion of the generated tuning data.

3. The system of claim 2, wherein performing one or more automated actions comprises predicting at least one dialogue state related to the input dialogue data by processing, using the one or more tuned artificial intelligence techniques, at least a portion of the input dialogue data.

4. The system of claim 3, wherein predicting at least one dialogue related to the input dialogue data using the one or more tuned artificial intelligence techniques comprises processing at least a portion of the input dialogue data in conjunction with at least a portion of the one or more prompts using at least one language model.

5. The system of claim 4, wherein the at least one language model comprises one or more of at least one encoder-decoder model and at least one decoder-only model.

6. The system of claim 3, wherein performing one or more automated actions comprises automatically generating at least one response, based at least in part on the at least one predicted dialogue state, in connection with an automated conversation system involved in the input dialogue data.

7. The system of claim 3, wherein performing one or more automated actions comprises automatically training at least a portion of the one or more tuned artificial intelligence techniques using feedback related to the at least one predicted dialogue state.

8. The system of claim 3, wherein performing one or more automated actions comprises automatically training at least one multi-domain automated conversation system using the at least one predicted dialogue state.

9. The system of claim 1, wherein obtaining input dialogue data comprises obtaining dialogue content involving at least one user and at least one automated conversation system, and query slot information related to the dialogue content.

10. The system of claim 1, wherein identifying one or more historical dialogue examples comprises comparing semantic similarity of one or more embeddings within the input dialogue data and one or more embeddings within the at least one historical dialogue dataset.

11. The system of claim 1, wherein generating one or more prompts comprises generating, based at least in part on the one or more historical dialogue examples, one or more prompts related to at least a portion of the input dialogue data in at least one of a zero-shot context and a few-shot context.

12. The system of claim 1, wherein the processor is further operatively coupled to the memory to execute the program instructions to:
train at least a portion of the one or more artificial intelligence techniques using at least a portion of the one or more prompts.

13. The system of claim 12, wherein training at least a portion of the one or more artificial intelligence techniques using at least a portion of the one or more prompts comprises encoding the at least a portion of the one or more prompts and using, via the one or more artificial intelligence techniques, the encoded prompts to predict one or more slot values in connection with the input dialogue data.

14. A computer program product comprising a computer readable storage medium having program instructions embodied therewith, the program instructions executable by a computing device to cause the computing device to:
obtain input dialogue data;
identify, from at least one historical dialogue dataset, one or more historical dialogue examples having at least a given semantic similarity to at least a portion of the input dialogue data;
generate, based at least in part on the one or more historical dialogue examples, one or more prompts related to at least a portion of the input dialogue data;
generate tuning data, associated with at least one dialogue state tracking task related to the input dialogue data, for one or more artificial intelligence techniques by augmenting at least a portion of the one or more prompts in connection with at least one given dialogue state value derived from at least a portion of the at least one historical dialogue dataset; and
perform one or more automated actions based at least in part on the generated tuning data.

15. The computer program product of claim 14, wherein performing one or more automated actions comprises automatically tuning the one or more artificial intelligence techniques using at least a portion of the generated tuning data.

16. The computer program product of claim 15, wherein performing one or more automated actions comprises predicting at least one dialogue state related to the input dialogue data by processing, using the one or more tuned artificial intelligence techniques, at least a portion of the input dialogue data.

17. A computer-implemented method comprising:
obtaining input dialogue data;
identifying, from at least one historical dialogue dataset, one or more historical dialogue examples having at least a given semantic similarity to at least a portion of the input dialogue data;
generating, based at least in part on the one or more historical dialogue examples, one or more prompts related to at least a portion of the input dialogue data;
generating tuning data, associated with at least one dialogue state tracking task related to the input dialogue data, for one or more artificial intelligence techniques by augmenting at least a portion of the one or more prompts in connection with at least one given dialogue state value derived from at least a portion of the at least one historical dialogue dataset; and
performing one or more automated actions based at least in part on the generated tuning data;
wherein the method is carried out by at least one computing device.

18. The computer-implemented method of claim 17, wherein performing one or more automated actions comprises automatically tuning the one or more artificial intelligence techniques using at least a portion of the generated tuning data.

19. The computer-implemented method of claim 18, wherein performing one or more automated actions comprises predicting at least one dialogue state related to the input dialogue data by processing, using the one or more tuned artificial intelligence techniques, at least a portion of the input dialogue data.

20. The computer-implemented method of claim 17, wherein software implementing the method is provided as a service in a cloud environment.
